(19) United States
(12) Patent Application Publication
(10) Pub. No.: US 2005/0264865 A1
(43) Pub. Date: Dec. 1, 2005

(54) Apparatus for determining an accurate color match

(76) Inventors: Christian Lambert, Laval (CA); Linda Bennett, Laval (CA); Jean Lefort, Lasalle (CA)

Correspondence Address: SEYFARTH SHAW LLP, 55 EAST MONROE STREET, SUITE 4200, CHICAGO, IL, 60603-5803, US

(21) Appl. No.: 11/072,728

(22) Filed: Mar. 4, 2005

Related U.S. Application Data
(60) Provisional application No. 60/549,564, filed on Mar. 4, 2004.

(51) Int. Cl. G02F 1/153

(52) U.S. Cl. 359/273

(57) ABSTRACT

The present invention is directed to a color matching apparatus using four KCMY films which may be adjusted along respective percentage scales (which are divided in 1 percentage point increments) through movement of slider buttons until the slider buttons are aligned with the required percentages and the desired combination of the four colors is visible in a viewing window.

### TECHNICAL FIELD

The present invention relates generally to an apparatus for determining an accurate color match from the four basic inks: Cyan, Magenta, Yellow and Black, and will find application in such fields as graphic design, printing and the fine arts.

### BACKGROUND

Tools or instruments for simulating the appearance of process-color paint or ink combinations based on various substrates and dot percentages of red, green and blue (RGB) or cyan, magenta, yellow and black (CMYK) are well known. Early examples include the color wheels developed by Tobias Mayer (1758), Johann Goethe (1810) and M. E. Chevreul (1864). More recently, Johannes Itten and Bill Murphy devised color guide wheels of their own that not only changed the way color was seen, but which continue to influence artists and designers right up to the present day. Color wheels are also available in software form. An example of such a software tool is the Color Wheel PrO™ which allows the creation of harmonious color schemes.

Despite the popularity of the color wheel, alternative devices for producing color combinations have also been created. A current example of this is the Graphic Arts Technical Foundation (GATF) Color Communicator. The GATF Color Communicator resembles a slide rule with four windows whose colors are indicated by graduated hues of printed CMYK. As the sliders (which determine the dot percentage of each hue) are gradually withdrawn on one side, a reference scale of printed dot percentages, from 10% to 100%, passes each window. Simultaneously, a color film of the same hue slides past a larger central viewing window. Within this central viewing window, the selected percentages of the process colors may be seen one on top of another. Their purpose is to simulate the effect of process-color inks printed in the same sequence.

The process-color films in the viewing window of the GATF Color Communicator are transparent, and their intensity is viewed against a white card. When the card is retracted and replaced by a substrate of the user's choice, the effect on printed inks on a chosen paper stock is more closely approximated.

The enclosure of the GATF Color Communicator is printed in a neutral gray tone so as to prevent the influence of unwanted color reflections. In addition to minimizing color reflections, another benefit of the neutral gray color is that the viewer's perception of contrast is not altered by the proximity of light or dark tones.

To produce a desired color, the four CMYK sliders are adjusted along their respective percentage scales (which are in increments of 10%) until the desired combination of the four is visible in the central viewing window.

The GATF Color Communicator is portable and affordable, making it accessible to a larger number of end-users, including students. However, the process-color films that are used in the GATF Color Communicator are colored in strips (or blocks) rather than in a continuum. This makes the GATF Color Communicator unsuitable for certain applications, such as printing jobs, that require a high degree of color matching and therefore very precise CMYK percentage specifications. Moreover, the casing of the GATF Color Communicator is made of a flexible cardboard which may not adequately protect the process-color films, with the result that the useful life of this instrument may be significantly reduced.

Alternatives to the GATF Color Communicator include the Pantone® fan guides and chip books. Each color indicates the percentages of CMYK required for its creation. While such tools or devices are helpful and handy, the accuracy of color match depends on the print medium used and therefore can vary significantly. The reproducibility of certain colors may also be very difficult to achieve.

In addition to the above tools, computer software and systems that are suitable for color matching are now available. An example of a suitable system is Normlicht's JUST™ Color Communicator. While the accuracy and reproducibility are greatly improved over the more traditional methods used for color matching, the system is unwieldy and not suitable for transportation. Such a system may also be quite costly.

Despite the advances in color matching technology, there remains a need for a portable, low cost instrument for determining color match accurately.

### SUMMARY

Accordingly, it is an object of the present invention to provide a convenient, portable means of determining an accurate color match.

There is therefore provided, in accordance with one aspect of the present invention, a color matching apparatus, comprising:
a first panel having spaced apart top and bottom surfaces, a window, a first, second, third and fourth slots, the window and the first, second, third and fourth slots forming openings in the first panel between the top and bottom surfaces;
a scale disposed on the top surface of the first panel, the scale being positioned and disposed to as to correspond with the first, second, third and fourth slots;
a first film acetate having opposed first and second ends and a position indicator operationally connected thereto, the first film having a gradually increasing intensity of black coloration from the first end to the second end;
a second film acetate having opposed first and second ends and a position indicator operationally connected thereto, the second film having a gradually increasing intensity of cyan coloration from the first end to the second end;
a third film acetate having opposed first and second ends and a position indicator operationally connected thereto, the third film having a gradually increasing intensity of magenta coloration from the first end to the second end;
a fourth film acetate having opposed first and second ends and a position indicator operationally connected thereto, the fourth film having a gradually increasing intensity of yellow coloration from the first end to the second end;
a second panel having spaced apart top and bottom surfaces;
wherein the fourth film is disposed above the top surface of the second panel, the third film is disposed above the fourth film, the second film is disposed above the third film, the first film is disposed above the second film and the bottom surface of the first panel is disposed above the first film such that the first film position indicator protrudes from the first slot, the second film position indicator protrudes from the second slot, the third film position indicator protrudes from the third slot and the fourth film position indicator protrudes from the fourth slot;
wherein the window and at least portions of each of the first, second, third and fourth films are in vertical alignment;
wherein movement of anyone of the position indicator of the first, second, third and fourth films produces a combination of coloration from the first, second, third and fourth films which is visible in the window corresponding to the position of each of the position indicator of the first, second, third and fourth films with respect to the scale.

In accordance with a another aspect of the present invention, the gradually increasing intensity of black coloration, the gradually increasing intensity of cyan coloration, the gradually increasing intensity of magenta coloration and the gradually increasing intensity of yellow coloration of the color matching apparatus vary in 1 percentage point increments.

In accordance with a further aspect of the present invention, the gradually increasing intensity of black coloration, the gradually increasing intensity of cyan coloration, the gradually increasing intensity of magenta coloration and the gradually increasing intensity of yellow coloration of the color matching apparatus are created using a negative having dots printed thereon using a dot printer having a high line-screen ruling.

In accordance with a further still aspect of the present invention, the first film is created using a negative having dots printed thereon with a screen angle of 45 degrees, the second film is created using a negative having dots printed thereon with a screen angle of 105 or 15 degrees, the third film is created using a negative having dots printed thereon with a screen angle of 75 degrees and the fourth film is created using a negative having dots printed thereon with a screen angle of 90 degrees.

The color matching apparatus is used in the following manner. To produce a desired color, the four KCMY films are adjusted along their respective percentage scales (which are divided in 1 percentage point increments) through movement of the slider buttons until the slider buttons are aligned with the required percentages and the desired combination of the four colors is visible in the viewing window.

### BRIEF DESCRIPTION OF THE FIGURES

Embodiments of the invention will be described by way of example only with reference to the accompanying drawings, in which:

FIG. 1 is an exploded perspective view of an embodiment of the apparatus of the present invention, showing its various components.

FIG. 2 is a exploded side cross-sectional view of the apparatus of FIG. 1

FIG. 3 is a perspective view of the apparatus of FIG. 1 when assembled.

### DETAILED DESCRIPTION

Definitions

Unless otherwise defined, the terms and expressions used in this application have the meanings that are commonly ascribed to them by those of skill in the relevant arts.

“CMYK”: This is short for Cyan-Magenta-Yellow-Black, and is pronounced as separate letters. CMYK is a color model in which all colors are described as a mixture of these four process colors. CMYK is the standard color model used in offset printing for full-color documents. Since such printing is based on the use of inks of these four basic colors, it is often called four-color printing.

“Color management system”, or “CMS”: A system for ensuring that colors remain the same regardless of the device or medium used to display the colors. This is very difficult since owing to the fact that different devices use different technologies and models to produce colors. In addition, color is highly subjective; the same colors look different to different people.

“Color matching”: The process of assuring that a color on one medium remains the same when converted to another medium. This is extremely difficult when different media use different color models. Color monitors, for example, use the RBG model, whereas process printing relies on the CMYK model. As color desktop publishing has evolved, color matching has gained more attention. Recent versions of Windows® and Macintosh® operating systems include color management systems (CMS) to assist in color matching.

“Color separation”: The act of decomposing a color graphic or photo into single-color layers. For example, to print full-color photos with an offset printing press, one must first separate the photo into the four basic ink colors: cyan, magenta, yellow, and black (CMYK). Each single-color layer is then printed separately, one on top of the other, to give the impression of infinite colors.

This type of color separation, mixing three or four colors to produce an infinite variety of colors, is called process color separation. Another type of color separation, called spot color separation, is used to separate colors that are not to be mixed. In this case, each spot color is represented by its own ink, which is specially mixed. Spot colors are effective for highlighting text but they cannot be used to reproduce full-color images.

Traditionally, process color separation has been performed photographically with different colored filters. However, many modern desktop publishing systems are now capable of producing color separations for graphics stored electronically. This capability is essential if full-color documents are to be created by computer and then printed using an offset printer. Color separation is not needed if printing is done directly to a color printer because in this case the printer itself performs the color separation internally.

“Halftone”: In printing, this refers to a continuous tone image, such as a photograph, that has been converted into a black-and white image. Halftones are created through a process called dithering, in which the density and pattern of black and white dots are varied to simulate different shades of gray.

In conventional printing, halftones are created by photographing an image through a screen. The screen frequency, measured in lines per inch, determines how many dots are used to make each spot of gray. In theory, the higher the screen frequency (the more lines per inch), the more accurate the halftone will be. However, actual screen frequencies are limited by the technology because higher screen frequencies create smaller, more tightly packed dots. If a low resolution device is used to print, better results may be obtained with a low frequency screen.

Modern desktop publishing systems can create halftones by simulating the conventional photographic process.

“Offset printing”: A printing technique whereby ink is spread on a metal plate with etched images, then transferred to an intermediary surface such as a rubber blanket, and finally applied to paper by pressing the paper against the intermediary surface. Most print shops use offset printing to produce large volumes of high-quality documents. Although the equipment and set-up costs are relatively high, the actual printing process is relatively inexpensive.

“Pantone® Matching System”, or “PMS”: This refers to a popular color matching system that is used by the printing industry to print spot colors. Most applications that support color printing allow colors to be specified by indicating the Pantone® reference name or number. This ensures that the correct color is obtained when the file is printed, even though the color may not look right when displayed on a monitor.

“Process Color”: Refers to the CMYK color model used in offset printing.

“RGB”: In contrast to offset printing, which relies on CMYK, display devices generally use a different color model called RBG, which stands for Red-Green-Blue. One of the most difficult aspects of desktop publishing in color is color matching, or properly converting the RGB colors into CMYK colors so that what gets printed looks the same as what appears on the monitor.

“Spot color”: Refers to a method of specifying and printing colors in which each color is printed with its own ink. In contrast, process color printing uses four inks (cyan, magenta, yellow, and black) to produce all other colors. Spot color printing is effective when the printed matter contains only one to three different colors, but it becomes prohibitively expensive for more colors.

Most desktop publishing and graphic applications allows for the specification of spot colors for text and other elements. There are a number of color specification systems for specifying spot colors, but Pantone® is the most widely used.

“True color”: Refers to any graphics device or software that uses at least 24 bits to represent each dot or pixel. Using 24 bits means that more than 16 million unique colors can be represented. Since humans can only distinguish a few million colors, this is more than sufficient to accurately represent any color image.

Color Match Apparatus

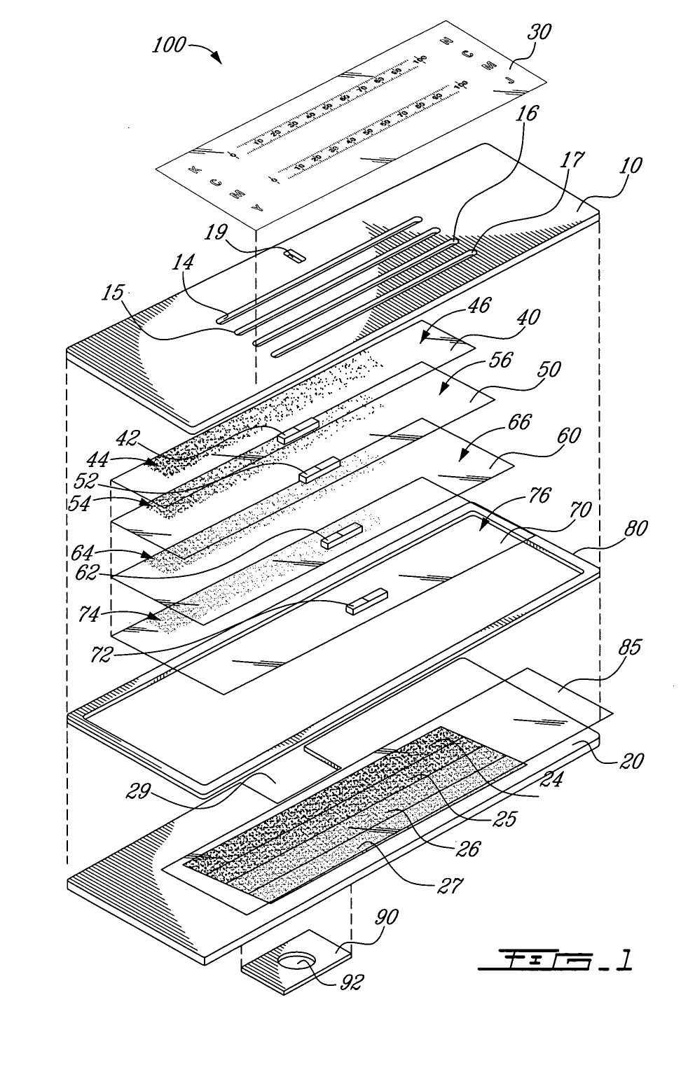

Referring to FIG. 1, the color match apparatus (100) comprises generally front (10) and back (20) panels, percentage scale (30), black (40), cyan (50), magenta (60) and yellow (70) color reference films with respective slider buttons (42, 52, 62, 72), a spacer (80), a transparent acetate protection film (85) and a support (90).

The back panel (20), which may be made of styrene, for example black styrene, comprises four color indicator bands, namely: black (24), cyan (25), magenta (26) and yellow (27), which may be created using a pressure-sensitive printed CMYK adhesive paper, and an opening (29). The transparent acetate protection film (85) may be positioned over the four color indicator bands (24, 25, 26, 27) in order to protect the adhesive paper from wear. Alternatively, a further embodiment may not include the transparent acetate protection film (85) and the four color indicator bands (24, 25, 26, 27).

The spacer (80), which may also be made of styrene, may be placed on top of the back panel (20) creating a cavity for receiving the four color references (40, 50, 60, 70). The color reference films (40, 50, 60, 70) may be color key film acetates, for example Fuji color key film acetates, with gradations of black, cyan, magenta and yellow, respectively, and comprise slider buttons (42, 52, 62, 72), respectively, which may be made, for example, of acrylic and having a central groove or other type of position indicator.

The black (40), cyan (50), magenta (60) and yellow (70) color reference films are developed using negatives, i.e. photo negatives, having gradated densities of dots printed thereon using a dot printer having a high line-screen ruling (for example, 150 Ipi) with screen angles of 45 degrees, 105 degrees (alternatively it may also be 15 degrees), 75 degrees and 90 degrees, respectively. The negatives for each of the four colors are created using screens placed at specific angles in order to eliminate moiré patterns when the resulting color reference films (40, 50, 60, 70) are superimposed.

The gradated dot densities of the negatives form a true “continuum” that allows the precise determination of color percentage of the resulting color reference films (40, 50, 60, 70) beginning at 0% and extending to 100% in a right to left direction in 1 percentage point increments, i.e. the color dots on the color reference films (40, 50, 60, 70) become progressively more numerous and densely positioned, and thus provide increased color intensity, when viewed from the right hand end to the left hand end.

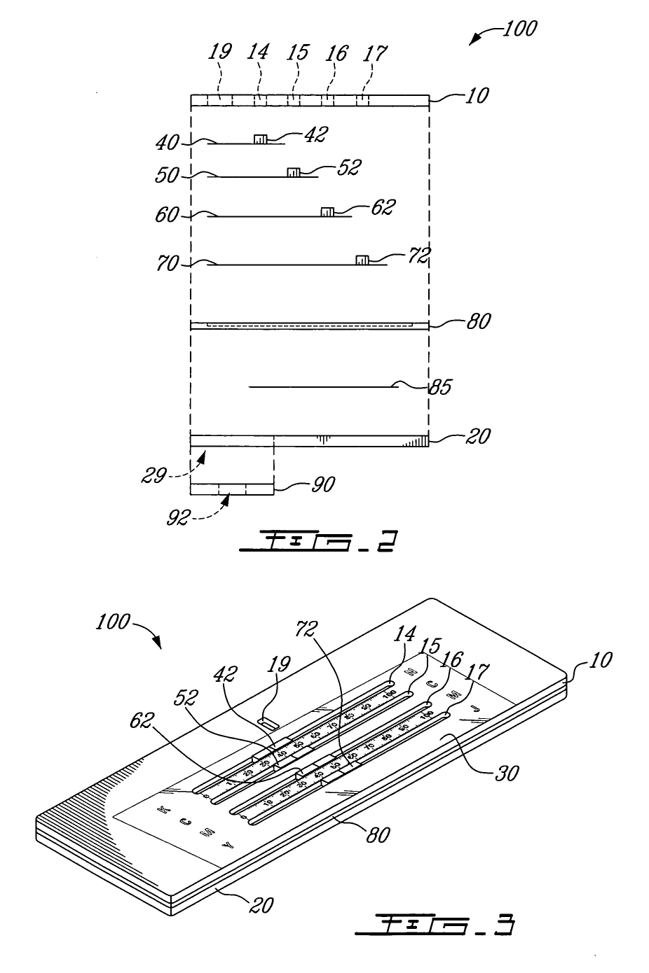

The front panel (10), which may be made of styrene, for example light grey styrene, comprises four slider slots (14, 15, 16, 17) and a viewing window (19). As may be seen in FIG. 2, the four slider slots (14, 15, 16, 17) are located such that when the front panel (10) is placed on top of the spacer (80) and color references (40, 50, 60, 70), each slider button (42, 52, 62, 72) protrudes from the front panel (10) through an associated slider slot (14, 15, 16, 17), respectively. The color reference films (40, 50, 60, 70) are of dimensions such that when their slider buttons (42, 52, 62, 72) are movably engaged with their associated slider slots (14, 15, 16, 17), they have colored portions (44, 54, 64, 74) which are superimposed one on top of the other and in alignment with the viewing window (19). Furthermore, each color reference film (40, 50, 60, 70) also has a clear portion (46, 56, 66, 76), respectively, such that each of the back panel (20) color indicator bands (24, 25, 26, 27) are visible through their associated slider slots (14, 15, 16, 17), respectively.

The support (90), which may be made of styrene, may be fitted to the back panel (20) just under opening (29) which is in alignment with the superimposed colored portions (44, 54, 64, 74) of the color reference film (40, 50, 60, 70) and the front panel (10) viewing window (19). Since the support (90) is of larger dimensions than the opening (29) it creates a cavity where different paper stock may be introduced so as to view, through the viewing window (19), the superimposed colored portions (44, 54, 64, 74) over the selected paper stock. Furthermore, the support (90) may have an aperture (92) though which pressure may be applied, for example using a finger, to the paper stock introduced in opening (29) so has to eliminate any distortion due to the possible presence of space between the color reference films (40, 50, 60, 70).

The is located such that it is in alignment with the front panel (10) viewing window (19) such that the superimposed colored portions (44, 54, 64, 74) of the color reference film (40, 50, 60, 70) may be view on.

Finally, the percentage scale (30), which has, for example, 8 UP format black characters indicating color percentages beginning at 0% and extending to 100% in a left to right direction in 1 percentage point increments, may be applied to the front panel (10) using a silkscreen process. It is to be understood that the percentage scale (30) may use different increments or that other scaling units may also be used, in which case the color reference film (40, 50, 60, 70) would be created using negatives having proportionate dot densities.

FIG. 3 shows the color match apparatus (100) once all of its components are assembled using, for example, methyl chloride glue.

Using the Color Match Apparatus

To produce a desired color, the four color reference films (40, 50, 60, 70) are adjusted along their respective percentage scales (30) through movement of the slider buttons (42, 52, 62, 72) until the central markers of each slider button (42, 52, 62, 72) are aligned with the required percentages indicated by the percentage scale (30). This results in the desired combination of the four colors being visible in the viewing window (19) of the front panel (10).

Conversely, the slider buttons (42, 52, 62, 72) may be moved until a desired color is viewed in the viewing window (19), at which time the slider buttons (42, 52, 62, 72) will indicate the percentage of black, cyan, magenta and yellow, respectively, required to obtain the desired color.

The color match apparatus of the present invention will find numerous applications. For example, it may be used by professional printers to get a better appreciation of the true color of a final print product before commencing the print job, which could save on time and money as well as eliminate the inevitable frustrations that are caused by inaccurate results. It may also be used by graphic designers as means to cross-check the colors that they see on their computer monitors. Moreover, artists may find the color match apparatus helpful in predicting the effect of mixing select colors of paint or ink.

Although the present invention has been described by way of particular embodiments and examples thereof, it should be noted that it will be apparent to persons skilled in the art that modifications may be applied to the present particular embodiment without departing from the scope of the present invention.

1. An apparatus for color matching, comprising:
a first panel having spaced apart top and bottom surfaces, a window, a first, second, third and fourth slots, said window and said first, second, third and fourth slots forming openings in said first panel between said top and bottom surfaces;
a scale disposed on said top surface of said first panel, said scale being positioned and disposed to as to correspond with said first, second, third and fourth slots;
a first film acetate having opposed first and second ends and a position indicator operationally connected thereto, said first film having a gradually increasing intensity of black coloration from said first end to said second end;
a second film acetate having opposed first and second ends and a position indicator operationally connected thereto, said second film having a gradually increasing intensity of cyan coloration from said first end to said second end;
a third film acetate having opposed first and second ends and a position indicator operationally connected thereto, said third film having a gradually increasing intensity of magenta coloration from said first end to said second end;
a fourth film acetate having opposed first and second ends and a position indicator operationally connected thereto, said fourth film having a gradually increasing intensity of yellow coloration from said first end to said second end;
a second panel having spaced apart top and bottom surfaces;
wherein said fourth film is disposed above said top surface of said second panel, said third film is disposed above said fourth film, said second film is disposed above said third film, said first film is disposed above said second film and said bottom surface of said first panel is disposed above said first film such that said first film position indicator protrudes from said first slot, said second film position indicator protrudes from said second slot, said third film position indicator protrudes from said third slot and said fourth film position indicator protrudes from said fourth slot;
wherein said window and at least portions of each of said first, second, third and fourth films are in vertical alignment;
wherein movement of anyone of said position indicator of said first, second, third and fourth films produces a combination of coloration from said first, second, third and fourth films which is visible in said window corresponding to the position of each of said position indicator of said first, second, third and fourth films with respect to said scale.

2. An apparatus as defined in claim 1, wherein said second panel further having an opening between said top and bottom surfaces and wherein said window, and at least portions of each of said first, second, third and fourth films, and said opening are in vertical alignment;

3. An apparatus as defined in claim 1, wherein said gradually increasing intensity of black coloration, said gradually increasing intensity of cyan coloration, said gradually increasing intensity of magenta coloration and said gradually increasing intensity of yellow coloration range in intensity from 0 percent to 100 percent.

4. An apparatus as defined in claim 3, wherein said gradually increasing intensity of black coloration, said gradually increasing intensity of cyan coloration, said gradually increasing intensity of magenta coloration and said gradually increasing intensity of yellow coloration vary in 1 percentage point increments.

5. An apparatus as defined in claim 1, wherein said gradually increasing intensity of black coloration, said gradually increasing intensity of cyan coloration, said gradually increasing intensity of magenta coloration and said gradually increasing intensity of yellow coloration are created using a negative having dots printed thereon using a dot printer having a high line-screen ruling.

6. An apparatus as defined in claim 5, wherein said dot printer has a line-screen ruling of 150 Ipi.

7. An apparatus as defined in claim 5, wherein said first film is created using a negative having dots printed thereon with a screen angle of 45 degrees, said second film is created using a negative having dots printed thereon with a screen angle of 105 degrees, said third film is created using a negative having dots printed thereon with a screen angle of 75 degrees and said fourth film is created using a negative having dots printed thereon with a screen angle of 90 degrees.

8. An apparatus as defined in claim 5, wherein said first film is created using a negative having dots printed thereon with a screen angle of 45 degrees, said second film is created using a negative having dots printed thereon with a screen angle of 15 degrees, said third film is created using a negative having dots printed thereon with a screen angle of 75 degrees and said fourth film is created using a negative having dots printed thereon with a screen angle of 90 degrees.

9. An apparatus as defined in claim 1, wherein said first, second, third and fourth films are color key films.

10. An apparatus as defined in claim 1, wherein said scale indicates a range of 0 to 100 percent.

11. An apparatus as defined in claim 10, wherein said scale varies in 1 percent increments.

12. An apparatus as defined in claim 10, wherein said scale is in 8 UP format.
